(19) United States
(12) Patent Application Publication
(10) Pub. No.: US 2005/0100147 A1
(43) Pub. Date: May 12, 2005

(54) Text messaging without a keyboard

(75) Inventors: Indran Naick, Cedar Park, TX (US); Jeffrey Kenneth Wilson, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/703,759

(22) Filed: Nov. 6, 2003

(51) Int. Cl. H04M 11/00; H04Q 7/20

(52) U.S. Cl. 379/93.24; 455/466

(57) ABSTRACT

Methods, devices, systems, and media are disclosed for text messaging concurrently using at least one text mode button and a set of numbered keys on a device, such as a telephonic device, wherein the keys are mapped to sets of characters. One embodiment includes enabling, in response to an exertion on a button, a text messaging mode for the device, and associating a character with an engagement of a key of the set of numbered keys, based upon the enabling. Embodiments further include displaying the character, displaying the character on a display in response to the engagement of the key based upon the associating a character, wherein the engagement of the key is concurrent with the exertion on the button.

### FIELD OF INVENTION

The invention generally relates to entering characters on a device having a standard numeric telephone keypad. More particularly, the invention relates to methods, devices, systems, and media for generating text messages via text mode buttons on cellular phones, personal data assistance (“PDA”) devices, pagers, land-line telephones, and other devices having a standard numeric phone pad without the addition of a keyboard.

### BACKGROUND

Typically, the term “text messaging” involves generating and sending short, text messages, no longer than a few hundred characters, between two or more devices, such as cellular phones, PDAs, pagers, and land-line telephones, collectively termed “text messaging devices.”

Text messages are generally sent by two methods: instant messaging and “short message service” (SMS). For instant messaging, a user sends a generated text message, called an instant message (IM), to a recipient. The IM is sent, in at least near-real time, from and to a computer or other Internet appliance/device. Normally, an IM system enables private communication, i.e., a private chat, between two individuals. The private chat begins when one of the two individuals realizes the presence of the other individual, and then sends a generated text message to the other individual. Common examples of IM systems include AIM™, ICQ™, MSN Messenger™, and Yahoo! Messenger™. These private chats are said to occur in a metaphorical “chat room” when multiple individuals participate in the chat.

The other method of sending a text message is SMS—sometimes known as IM in the wireless world. However, the process is not quite as “instant” as wired IM because SMS, unlike IM, does not first determine whether the recipient is online; that is, “presence” of the recipient is not first determined. Instead, the slight delay arises because an SMS text message first goes to a server for storage, and then goes to the intended recipient, i.e., another cellular phone, fax machine and/or IP address, whereupon the SMS text message is deleted from the server. In short, an SMS is like sending an e-mail.

It is necessary to generate text messages, however, before sending them. Generating these text messages is largely dependent on the devices from which they emanate. For example, some devices require a user to navigate a main button to a text messaging mode through use of a supposedly intuitive iconic interface on an associated display. Once in this text messaging mode, the user generally makes use of a standard phone number pad found on these devices. These phone number pads include a grouped set of letters mapped to each numeric key for use in generating, i.e., typing in, a text message. For example, the letters “a,” “b,” and “c” are mapped to the number 2 key, the letters “d,” “e,” and “f” are mapped to the number 3 key, and so on.

For some such devices, the user presses the number 2 key once to make an “a” appear on the associated display, presses the number 2 key twice, in rapid succession, to make a “b” appear, presses the number 2 key four times, in rapid succession, to make an “A” appear, and so forth. These types of devices require very time consuming and heavy digital action to generate the simplest of text messages.

In other devices with grouped sets of letters mapped to the individual numeric keys, the user, for example, presses the number 2 key, whereby all of the letters, numbers, and symbols associated with that key appear on the display. The user then presses a scrolling navigational button, usually disposed on the same surface as the standard phone number pad, to select the desired letter, number, or symbol. Although these devices are also effective at generating a text message, such devices require the user to invest time, when swiftness is often a primary goal. Further, it can be difficult to click several keys for words of few characters, especially when capitalizations, symbols, emoticons, diacritical marks, and so on, are desired in a text message.

Another more recent solution involves the introduction of miniature keyboards in new text messaging phones such as the Nokia™ 3300 and 6800 cellular phones. The Nokia™ 3300 incorporates a keyboard rather than a numeric pad. The Nokia™ 6800 incorporates a flip phone that unfolds to provide the user with a small keyboard. These keyboards are QWERTY design, offering all the keys of a standard keyboard. Since the keys are very small and very close together on these small keyboards, they are awkward to use. In addition, the number of keys increases the complexity of the design and the number of components that can fail.

Prior attempts to overcome the difficulties in swift text messaging also include devices that guess at words by searching through potential combinations of letters that make the desired words. For example, after the user types in “ab” of a partial text message, such devices display a host of words that the device thinks the user may be spelling. In this example, the device may display “abbey,” “aberration,” “absolve,” “about,” etc. Obviously, the problem with proper word guessing can be, by its very nature, incorrect, and, requires the user to reject multiple entries to prevent entry of the incorrectly guessed word. Further, word guessing devices may require the user to ignore distractions associated with incorrect guesses while typing the message. Further still, these types of devices require a significant amount of memory to store the available words, and this is problematic because memory is often limited due to the small size of such devices.

To further highlight the inadequacy of these prior attempts to provide the text messaging community with acceptably fast and facile capabilities for generating text messages, a dictionary of abbreviations, of sorts, is being developed to facilitate text messaging. In text messaging parlance, these abbreviations are typically learned over time, and substitute for laborious typing of words and phrases, such as AYEC for “at your earliest convenience,” BAK for “back at keyboard,” PMFI for “pardon me for interrupting,” ROTFL for “rolling on the floor laughing,” and SMHID for “scratching my head in disbelief.”

Regardless whether sending an IM or SMS text message, it is apparent that there is a need for devices, methods, systems, and media for generating text messaging that overcomes these problems, and specifically does not require an additional fold-out keyboard, scrolling through improperly guessed-at words, and significantly increased storage requirements.

### SUMMARY OF THE INVENTION

Embodiments of the invention generally provide methods, systems, and media to configure, into a text mode, a set of numbered keys on a device for text messaging without the use of a keyboard. One embodiment provides a method for text messaging using a set of numbered keys on a device. The method generally includes enabling, in response to an exertion on a button, a text messaging mode for the device, and associating a character with an engagement of a key of the set of numbered keys, based upon the enabling. The method further includes displaying the character on a display in response to the engagement of the key based upon the associating a character, wherein the engagement of the key is concurrent with the exertion on the button.

In another embodiment, the invention provides a device for text-messaging. The device generally includes a set of keys associated with numbers, and at least one mode button to enable a text messaging mode, wherein the text messaging mode associates a different character set with the set of keys. The device further includes an interpreter coupled with the mode button and the set to determine a character in response to concurrently engaging one of the keys in the set and the at least one mode button. Still further, the device includes a display in communication with the interpreter to display the character.

In yet another embodiment, the invention provides a machine-accessible medium containing instructions, which when executed by a machine, cause the machine to perform operations. The operations generally include enabling, in response to an exertion on a button, a text messaging mode for the device, and associating a character with an engagement of a key of the set of numbered keys, based upon the enabling. The operations further include displaying the character on a display in response to the engagement of the key based upon the associating a character, wherein the engagement of the button is concurrent with the exertion on the button.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a system for text messaging in accordance with the disclosed invention.

FIG. 2 depicts an example embodiment of a device for text messaging in accordance with the disclosed invention.

FIG. 3 depicts an example embodiment of a method for text messaging in accordance with the disclosed invention.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, devices, methods, and media for generating and sending text messages are contemplated. Embodiments include hardware and/or software for generating a text message on a device having a set of numbered keys, such as those normally found on cellular phones, personal digital assistance (PDAs) devices, land-line telephones, pagers, and similar devices. More specifically, embodiments include one or more buttons that may be depressed to modify, at least temporarily, the mode of operation associated with interpretation of the set of numbered keys to facilitate text messaging. In some embodiments, modes of operation may cause keys of the numeric pad to be interpreted as uppercase letters, lowercase letters, emoticons, symbols, diacritical marks, or other characters. In further embodiments, multi-directional keys may be incorporated into the numeric pad to produce more than one character per key depending upon the direction of force applied to the keys. For example, one embodiment includes keys that may be pressed in one of three different directions to produce one of three different characters.

After generating a text message, a user may store the text message on the device by making use of associated memory. Storing the text message is appropriate for many reasons, including, for example, an incomplete text message needing completion at a later time, a text message generated only for personal use, and a text message for use in conjunction with speed dialing capabilities on a telephone.

A user may also send a generated text message to a recipient for communicative purposes. To send the text message, the user generally engages a button associated with the device to send the text message to a receiving device by means of a commercial provider offering instant messaging (IM'ing) or short message service (SMS).

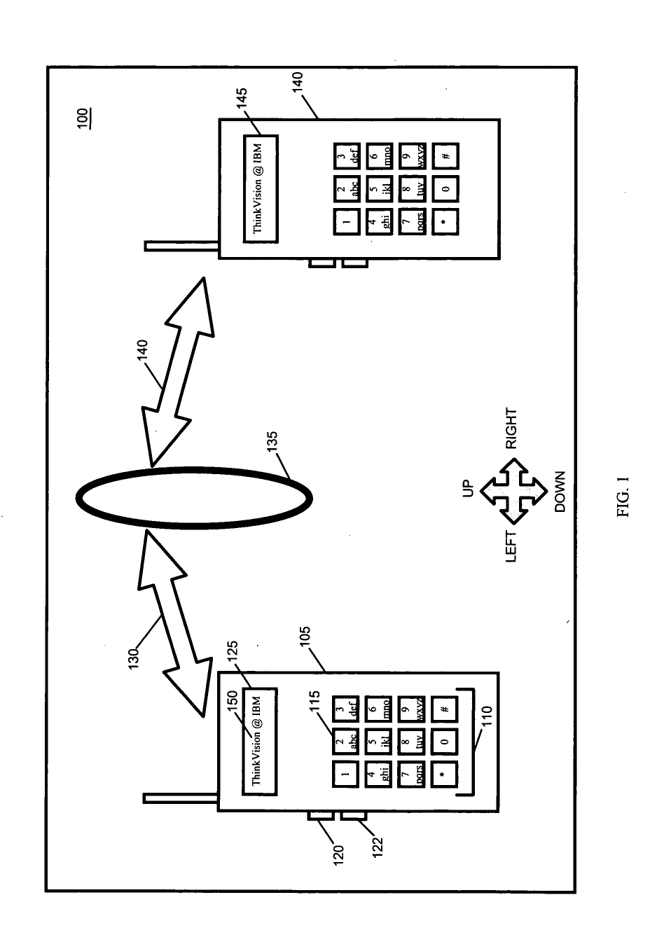

Turning now to the drawings, FIG. 1 depicts an embodiment of a system 100 for generating and sending text messages. The system 100, depicts a device 105, such as a cellular phone 105, with a numeric phone key pad 110, wherein each numeric key 115 is optionally capable of multi-directional movement, i.e., capable of movement to the left, to the right, down, up, and so forth. Upon engagement of a “shift” text mode button 120 and/or a “control” text mode button 122, and the user's concurrent exertion of a directional exertion on one of the numeric keys 115, a pre-assigned character mapped to the specific directional exertion is displayed on the display 125 of the device 105. By example, FIG. 1 shows repetition of these steps on the device 105 to result in a combination of characters to form the text message 150 of “ThinkVision @ IBM,” as shown on the display 125.

Numeric keypad 110 includes twelve keys such as the “2” key 115 that are typically found on telephones such the depicted cellular phone 105. The numeric keypad 110 may be designed to operate as a standard telephone keypad unless a user depresses one or both of the text mode buttons 120 and 122. Unlike a typical numeric keypad, numeric keypad 110 may include one or more multi-directional buttons. In particular, the numeric key for the number eight on a standard numeric keypad typically represents the letters “t”, “u”, and “v”. Pressing shift text mode button 120 while simultaneously pressing the numeric key eight to the left may produce an uppercase “T” in a text message, whereas pressing the numeric key eight directly down produces “U,” and pressing to the right produces “V”. On the other hand, depressing control text mode button 122, and simultaneously pressing numeric key eight to the right produces a lowercase “t”, while pressing directly down produces “u”, and pressing to the right produces “v”.

In some embodiments, pressing on a key such as key 115 engages one or more of three contacts, where each contact indicates a different direction of pressure for key 115. More specifically, when the user presses directly down on key 115, three contacts may be engaged for a multi-directional key capable of distinguishing three directions of movement. Pressing key 115 to the right, on the other hand, may engage two contacts, for example, the rightmost contact and the center contact. Similarly, pressing key 115 to the left may engage, for example, the leftmost contact and the center contact. In other embodiments, key 115 may be a rocker type of button that only engages one of the three contacts depending upon the direction of the applied force. In further embodiments, more than three contacts may distinguish more than three distinct directions of movement.

As an illustration, the numeric keys seven and nine on a typical numeric keypad represent four letters, “pqrs” and “wxyz”, respectively. When the keys of the numeric keypad 110 include keys capable of distinguishing three distinct directions of movement, one of the letters such as the fourth letters of numeric keys seven and nine, “s” and “z”, may be produced by pressing control text mode button 122 and the numeric keys one and zero, respectively. In other embodiments, numeric keys seven and nine may include four way directional keys, producing, for example, “r” when the key is pressed upward and “s” when the key is pressed downward while simultaneously pressing control key 122 or “R” and “S” respectively when pressing shift key 120. Further characters may be achieved by including associating the symbols and emoticons with the numeric keys “1”, “*”, “0”, and “#”, additional mode buttons, and/or incorporating four-way keys for one or more of the numeric keys on the numeric keypad 110.

In other embodiments, such as with PDAs, the numeric keypad 110 may be incorporated into a display that includes capacitive contacts, pressure sensitive contacts, or the like. For instance, the numeric keys may be drawn on the display. A thin, clear layer of circuitry on top of the screen provides a grid of contacts to interpret the touch by the user. When such a display is touched by the user's finger or a stylus, the location of the touch, as determined by the grid of contacts, may be compared with the location of keys as displayed on the grid. Then, depending upon where the display is touched, the touch is interpreted as directional pressure exerted on a key.

Turning to the text mode buttons 120 and 122, they determine the mode of operation of the keys on the numeric keypad 110. In some embodiments, the text mode buttons 120 and 122 include a single contact to distinguish between the application and absence of applied pressure. Whether one or both of the text mode buttons 120 and 122 have pressure applied, the interpreter determines the character set associated with the keys of numeric keypad 110. In other embodiments, one or more text mode buttons 120 and 122 are incorporated into device 105, wherein each is capable of distinguishing more than one direction of pressure. For example, text mode button 120 may include a rocker button or a slide switch that can be pressed up or down, each direction indicating a different mode of operation. In such embodiments, one or more mode buttons and/or switches may be implemented to select text modes.

In many embodiments, text mode buttons 120 and 122 may be incorporated into the device 105 as dedicated buttons for determination of the text modes. For instance, as dedicated buttons, the text mode buttons may be pressed at any time to offer an expanded character set via numeric keypad 110. In other embodiments, one or more buttons existing on device 105 may be utilized as text mode buttons when device 105 is in a text messaging mode. For example, many cellular phones incorporate button(s) for volume control. When device 105 is not in a text messaging mode, the user may use the buttons for volume control. On the other hand, the user may select a text messaging mode and then the volume control button(s) may be utilized as text mode buttons 120 and 122.

In still further embodiments, multiple text messaging modes may be available to the user and each text messaging mode may associate text mode buttons 120 and 122 with different character sets or combinations of character sets. For example, in a first text messaging mode, keys of numeric keypad 110 may be associated with symbols when text mode button 120 is depressed and upper case letters when text mode button 122 is depressed. In a second text messaging mode, keys of numeric keypad 110 may be associated with lowercase letters when text mode button 120 is depressed and uppercase letters when text mode button 122 is depressed.

As the user presses numeric keys in combination with shift and/or control buttons 120 and 122, an interpreter determines the character associated with the user input and displays the resulting characters on display 150. Internal to the device 105, the interpreter includes combinations of hardware and software that interpret a user's simultaneous depression of both a numeric key and shift and/or control buttons 120 and 122 with an associated character for resultant display. For instance, pressing shift key 120 and control key 122 in combination with the “1” key may be associated with the “1” symbol by the interpreter and the interpreter may display the “1” symbol as the next character in the text message. Alternatively, pressing shift key 120 in combination with the “2” key may be associated with the “A” letter by the interpreter and the interpreter may display the “A” letter as the next character in the text message.

After generating a text message such as the example text message 150 “ThinkVision @ IBM” shown in FIG. 1, transmission of a text message 150 may occur. As shown in FIG. 1, a user may cause the device 105 to send the text message 150 via wireless communication 130 through transmission from a transmitter in the device 200 to a relay station, such as a cell phone tower, and then on to a central receiving/sending server 135. The server 135 may locate the targeted receiving device, such as device 140, or could transmit the text message to a relay station located near the receiving device 140 for ultimate transmission to a receiver in the receiving device 140 by another transmission. As a result of the completed transmission, FIG. 1 shows a generated text message 125 on the device sent and transmitted through wireless communication 130, 140 to device 140 and displayed on display 145.

Although FIG. 1 depicts the sending device 105 and receiving device 140 as being cellular phones, devices 105, 140 could equally be laptop computers, PDAs, desktop computers, server, telephones, etc. Similarly, although wireless communication is depicted in FIG. 1, transmission and receipt of generated text messages may equally occur by wired communication.

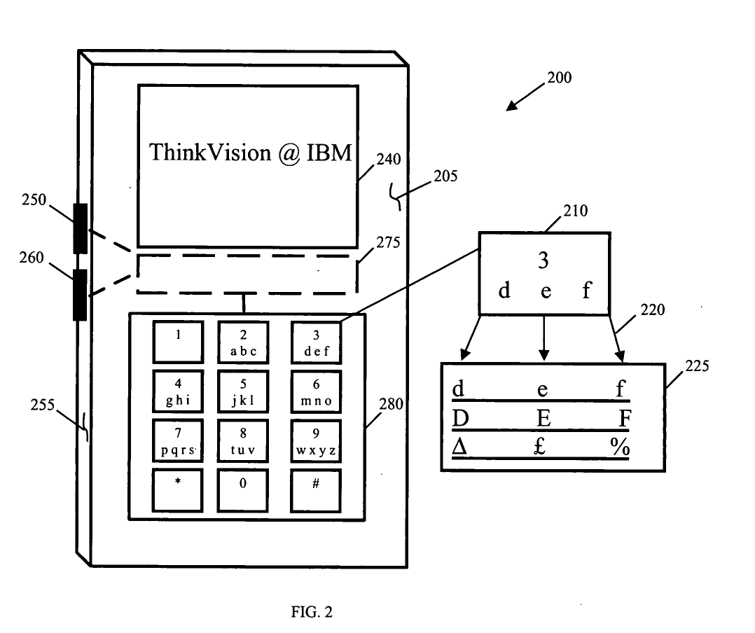

Turning now to FIG. 2, an example embodiment of a device 200 for text-messaging is disclosed. The device 200 may include a PDA, cellular phone, wired phone, portable phone, or similar device with a numeric keypad 280 that provides text messaging capabilities and/or directories having names associated with telephone number entries. For instance, business telephones typically include numeric keypads for dialing telephone numbers and entering names into a directory having names associated with phone numbers. The numeric keypads, such as numeric keypad 280, may include multi-directional keys having the capability to distinguish between two or more different directions of movement. In response to entering a text mode to type a name associated with a telephone number, an interpreter 275 may distinguish between the multiple directions of movement of each key to facilitate entry of lowercase letters. Further, when a text mode button, such as text mode button 250 and/or 260 is pressed in combination with one of the keys on the numeric keypad 280, uppercase letters may be entered via numeric keypad 280.

The device 200 includes numeric keypad 280, mode buttons 250 and 260, interpreter 275, and display 240. Numeric keypad 280 may include a set of numbered keys disposed on a primary surface 205 of the device 200, and one or more of the keys may be capable of multiple directions of movement. For example, key 210 has multi-directional capability with three particular directions of movement such as movement 220. To maximize the device's 200 capability for text messaging, all of the keys have a capability for multiple direction of movement. In this manner, each key's direction of movement, when coupled with a chosen text mode, enormously expands the number of characters possible for user to choose in order to generate and send a text message.

Mode buttons 250, 260 may be disposed on the primary surface 205 of the device 200, such as a desktop phone, or on a side surface 255 of the device 200, such as for a handheld device. The exact locations of mode buttons 250 and 260 on the device 200 are not as important as is the purpose behind choosing the location of the position on the device 200. The purpose is to enable facile manipulation for a user to rapidly generate a text message, which often requires switching between modes 250, 260 to enable desired capitals, numbers, symbols, diacritical marks, emoticons, and so on. In the present embodiment, mode buttons 250 and 260 are located on side 255 of device 200 to facilitate use of the different text modes via pressure exerted by a user's thumb while simultaneously holding device 200, and, thereby, freeing the user's second hand to pellet the primary surface 205 of the device 200 with digital action. In addition to location, and in keeping with their facile and rapid use, mode buttons 250, 260 may be engaged by pressing, pushing, rolling, or sliding the button, a choice that depends on the desired embodiment of manufacture.

When the user enables the text messaging mode of the device 200 by depressing, for example, a “shift key” mode button 250, and concurrently exerts a directional force on one of the multi-directional keys such as key 210, or locks the mode button into position, then a unique character, whether a letter (e.g., A, a, α), symbol (e.g., ®, ♥, ©), diacritical mark (e.g., !, ?, [symbol] ), emoticon (e.g., [symbol] , [symbol] , [symbol] ), number, etc., is displayed. Inclusion of another mode button 260, such as a “control key,” is associated with a further set of characters, which are similarly produced upon exertion of a directional force 220 on one of the multi-directional keys 210.

To permit generation of text messages, the device 200 further includes an interpreter 275, inside of the device 200, that couples (shown by dashed lines in the FIG. 2) to the mode button(s) 250 and 260 and to numeric keypad 280. Interpreter 275 understands and interprets a user's directional exertion on one of the multi-directional keys such as key 210, and the user's exertion on mode buttons 250 and 260 to permit generation of a user chosen character. The interpreter 275, itself, may include hardware coupled with software that such as a processor coupled with memory that includes one or more tables of characters mapped to the keys of numeric keypad 280.

In some embodiments, the character set associated with each text mode may be adapted by a user to customize the interface for that user based upon the characters and/or character sets most utilized. For example, a user may decide that emoticons will likely be incorporated into each text message, or at least more often than upper case letters are utilized. The user may then interface with the interpreter via a menu system for hand held device 200 to set to assign an emoticon character set to the text mode associated with text mode button 250. Thereafter, when text messaging, the user may depress text mode button 250 and select an emoticon by simultaneously pressing a numeric key of numeric keypad 280.

Still further, the present embodiment includes a display 240 in communication with the interpreter 275 to display the character or characters in the text message. Chart 225 shows nine characters associated with a multi-directional key 210, any of which appear on the display 240 as a result of using the device by the following example method. By simultaneously pressing text mode button 250 and pressing key 210 in downward left direction, then a “d” appears on the display 240. Similarly, simultaneously pressing text mode button 250 and pressing key 210 in downward center direction, displays an “e” on the display 240, and, pressing in a downward right direction displays an “f” on the display 240. For display of one of the characters in the second row of chart 225, simultaneously pressing text mode button 260 and pressing key 210 in downward left direction, displays a “D” on the display 240. Similarly, by pressing text mode button 260 and pressing key 210 in downward center direction, displays an “E” on the display 240, and, pressing in a downward right direction displays an “F” on the display 240. And for display of one the characters in the third row of chart 225, by simultaneously pressing text mode buttons 250 and 260, and pressing key 210 in downward left direction, displays a “A” on the display 240. Under the same dual engagement of text mode buttons 250 and 260, and pressing key 210 in downward center direction, a “ ” is displayed on the display 240, whereas pressing key 210 in a downward right direction displays a “%” on the display 240.

As for the type of display 240, the display 240 is a screen already part of the device 200, such as the screen on most cellular phones. In alternate embodiments, display 240 is a screen in association, via wiring or wireless communication, with the device 200.

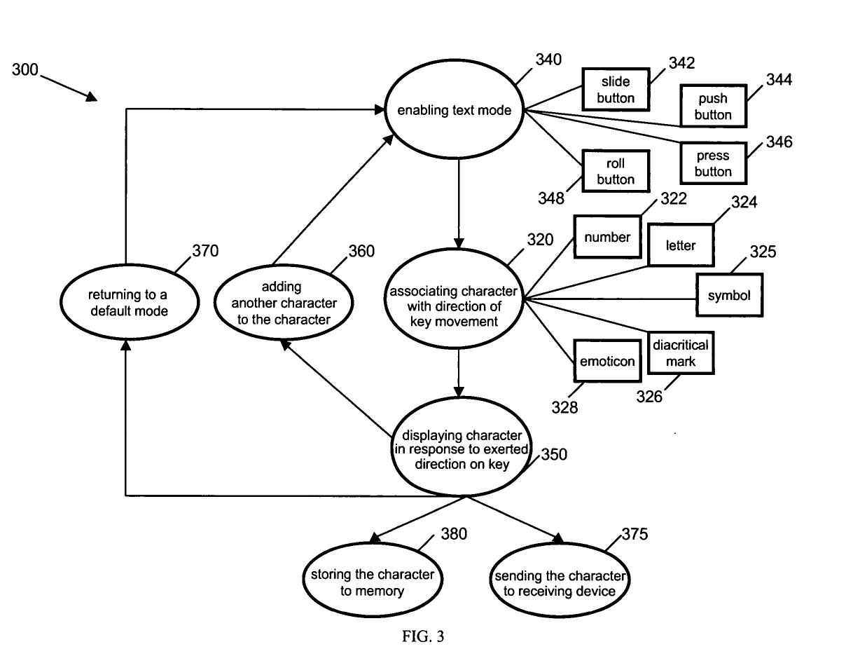

Turning now to FIG. 3, another aspect of the invention is disclosed. In particular, an embodiment of a flowchart 300 for text messaging using a set of numbered keys on a telephonic or related device is disclosed. Flowchart 300 is for a device, such as device 200 shown in FIG. 2, wherein at least two of the keys on the device 200 permit multiple directions of movement.

Flowchart 300 begins by enabling 320 a text mode on the device 200. Enabling 320 a text mode may, for instance, associate a character set of capital letters with the numeric keypad in response to exertion of force on a “shift key” text mode button. To enable a text mode, a user may exert a force on a mode button by pressing a button 322, pushing a button 324, sliding a button 326, or rolling a button 328.

After the text mode is enabled, a character (e.g., number 342, letter 344, symbol 345, diacritical mark 346, emoticon 348, etc.) associated with the mode may be displayed 350 in response to an exertion of a directional force on one of the keys. The character may depend upon which of multiple directions of movement that the user exerts on a key of a numeric keypad and the character set associated with the text mode. For example, and with reference to FIGS. 2 and 3, displaying 350 the character “D” as shown in FIG. 2 at 225, occurs when the user pushes multi-directional key 210 in a downward left direction (i.e., the associated character with this direction on this key), while the user concurrently enabling 340 the “shift key” text mode button. In yet another similar example, and under the same associating 340, but this time, enabling a text mode by exerting a force on a “control key” text mode button while concurrently exerting a downward left direction on the number “3” key results in displaying 350 the character “Δ” as shown in FIG. 2 at 225.

In some embodiments, the mode of operation returns 370 to a default mode after displaying 350 the character unless a text mode button remains engaged. Returning 370 to a default mode may involve returning to a non-text mode after displaying 350 a character associated with a text mode. In such embodiments, to use the expanded character sets, the user enables 320 a text mode again to continue. However, if the text mode button remains engaged, as is possible in some situations, then the user remains in the text mode, and continues to type a desired text message.

In line with displaying 350 text messages that are greater than one character in length, flowchart 300 further includes adding 360 at least another character to the displayed character. In particular, the user repeatedly presses keys on the numeric keypad, adding 360 characters to the desired text message, and displaying 350 responds to each exertion of directional force on the same or other keys. Until termination, for example, by turning off the device, saving the text message and returning to non-text mode, deleting the text message, sending the text message, and so on, the text message is only limited in length by the device's physical limitations, such as memory size, or limitations imposed by a text messaging service provider with regards to, e.g., character length.

In several embodiments, rather than displaying 350, or in addition to displaying 350, a text message, the character(s) of the text message generated by the user are stored 380 in memory, such as a video buffer or other memory allocated for storing text messages. In addition to volatile memory such as randomly accessed memory (RAM) for temporarily storing 380 the character(s) in the device 200, further embodiments include, e.g., nonvolatile memory such as flash memory, for permanently storing 380 the text message.

Once the user completes the text message, the character(s) are sent 375 to a receiving device. Sending 375 the text message may include sending the text message from, e.g., a wireless device, such as a cellular phone or PDA, by a transmitter in the device and through a “short message service” (“SMS”) such as Verizon™, AT&T Wireless™, and Sprint™. Sending 375 the text message may also include sending the text message over a wired, landline network such as telephone wires. Further methods for sending 375 text messages are contemplated.

Another embodiment of the invention is implemented as a program product for use with a computer system such as, for example, the system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

1. A method for text messaging using a set of numbered keys on a device, the method comprising:
enabling, in response to an exertion on a button, a text messaging mode for the device;
associating a character with an engagement of a key of the set of numbered keys, based upon the enabling; and
displaying the character on a display in response to the engagement of the key, based upon the associating, wherein the engagement of the key is concurrent with the exertion on the button.

2. The method of claim 1, further comprising returning to a default mode after the responding unless the button remains engaged.

3. The method of claim 1, further comprising storing the character to memory associated with the device.

4. The method of claim 1, further comprising sending the character to a receiving device in communication with the device.

5. The method of claim 1, wherein the enabling comprises enabling in response to the exertion selected from a group comprising pressing, pushing, sliding and rolling.

6. The method of claim 1, wherein the associating comprises adding at least one other character to the character by repeating the associating.

7. The method of claim 1, wherein the associating comprises distinguishing between multiple directions of movement of the key.

8. The method of claim 1, wherein the associating a character comprises selecting a character from a group comprising numbers, letters, symbols, diacritical marks, and emoticons.

9. A device for text messaging, the device comprising:
a set of keys associated with numbers;
at least one mode button to enable a text messaging mode, wherein the text messaging mode associates a different character set with the set of keys;
an interpreter coupled with the mode button and the set to determine a character in response to concurrently engaging one of the keys in the set and the at least one mode button; and
a display in communication with the interpreter to display the character.

10. The device of claim 9, further comprising memory associated with the device for storing the character.

11. The device of claim 9, further comprising a transmitter for transmitting the character to a receiving device in communication with the device.

12. The device of claim 9, wherein the at least one mode button is a type selected from the group comprising a pushable button, a pressable button, a slideable button and a rollable button.

13. The device of claim 9, wherein the set of keys comprise a capability for multi-directional movement, wherein the capability associates a different directional movement with a different character.

14. The device of claim 9, wherein the device comprises a cellular phone.

15. The method of claim 9, wherein the at least one mode button returns to a non-text messaging mode unless the button remains engaged.

16. The device of claim 9, wherein the character comprises a type selected from a group comprising numbers, letters, symbols, diacritical marks, and emoticons.

17. The device of claim 9, wherein the at least one mode button is disposed on a different surface of the device than the set of keys.

18. A machine-accessible medium containing instructions, which when executed by a machine, cause the machine to perform operations, comprising:
enabling, in response to an exertion on a button, a text messaging mode for the device;
associating a character with an engagement of a key of the set of numbered keys, based upon the enabling; and
displaying the character on a display in response to the engagement of the key, based upon the associating, wherein the engagement of the key is concurrent with the exertion on the button.

19. The machine-accessible medium of claim 18, wherein the operations further comprise instructions for returning to a default mode after the responding unless the button remains engaged.

20. The machine-accessible medium of claim 18, wherein the operations further comprise instructions for storing the character to memory associated with the device.

21. The machine-accessible medium of claim 18, wherein the operations further comprise instructions for sending the character to a receiving device in communication with the device.

22. The machine-accessible medium of claim 18, wherein the operations for the enabling comprise instructions for enabling in response to the exertion selected from a group comprising pressing, pushing, sliding and rolling.

23. The machine-accessible medium of claim 18, wherein the operations for the associating comprises instructions for adding at least one other character to the character by repeating the displaying until terminating.

24. The machine-accessible medium of claim 18, wherein the operations for the associating comprises instructions for distinguishing between multiple directions of movement of the key.

25. The machine-accessible medium of claim 18, wherein the operations for the associating comprises instructions for selecting a character from a group comprising numbers, letters, symbols, diacritical marks, and emoticons.
